(19) United States
(12) Patent Application Publication
(10) Pub. No.: US 2018/0342338 A1
(43) Pub. Date: Nov. 29, 2018

(54) RARE-EARTH MAGNET AND METHOD FOR PRODUCING RARE-EARTH MAGNET

(71) Applicant: Sumitomo Electric Industries, Ltd., Osaka-shi (JP)

(72) Inventors: Shigeki Egashira, Itami-shi (JP); Kazunari Shimauchi, Itami-shi (JP); Toru Maeda, Itami-shi (JP)

(21) Appl. No.: 15/778,289

(22) PCT Filed: Nov. 23, 2016
(86) PCT No.: PCT/JP2016/084682

§ 371 Date: May 23, 2018

(30) Foreign Application Priority Data
Nov. 24, 2015 (JP) 2015-229116

(51) Int. Cl. H01F 1/057; H01F 1/059; H01F 41/02; C22C 38/00

(52) U.S. Cl. CPC H01F 1/0577; H01F 1/059; C22C 38/005; H01F 41/0293; H01F 41/0266; H01F 1/0578

(57) ABSTRACT

A rare-earth magnet containing Sm, Fe, and N contains an Me and B serving as additive elements, the Me representing at least one element selected from elements in groups 4, 5, and 6 of the periodic table, and a nanocomposite microstructure including an Fe phase, a SmFeN phase, and an MeB phase, in which the SmFeN phase includes at least a Sm₂Fe₁₇Nₓ phase selected from the Sm₂Fe₁₇Nₓ phase and a SmFe₉N_{y} phase, the volume percentage of the SmFe₉N_{y} phase in the microstructure is 65% or less by volume, the atomic percentage of the total content of the Me and B is 0.1 at % or more and 5.0 at % or less with respect to the total amount of Sm, Fe, the Me, and B, and the atomic percentage of Fe in all phases of compounds each containing at least one of the Me and B is 20 at % or less.

### TECHNICAL FIELD

The present disclosure relates to a rare-earth magnet and a method for producing a rare-earth magnet. The present application claims priority to Japanese Patent Application No. 2015-229116 filed in the Japan Patent Office on Nov. 24, 2015, which is hereby incorporated by reference herein in its entirety.

### BACKGROUND ART

Rare-earth magnets containing rare-earth-iron-based alloys that contain rare-earth elements and iron and that contain rare-earth-iron-based compounds serving as main phases are widely used as permanent magnets used for motors and power generators. Typically, Nd—Fe—B-based magnets (neodymium magnets) containing Nd—Fe—B-based compounds (for example, Nd₂Fe₁₄B) serving as main phases and Sm—Fe—N-based magnets containing Sm—Fe—N-based compounds (for example, Sm₂Fe₁₇N₃) serving as main phases are known as rare-earth magnets (for example, see PTLs 1 and 2).

### CITATION LIST

### Patent Literature

PTL 1: Japanese Unexamined Patent Application Publication No. 10-312918

PTL 2: Japanese Unexamined Patent Application Publication No. 2015-128118

### SUMMARY OF INVENTION

A rare-earth magnet according to the present disclosure is a rare-earth magnet containing Sm, Fe, and N. The rare-earth magnet contains an Me and B serving as additive elements, the Me representing at least one element selected from elements in groups 4, 5, and 6 of the periodic table. The rare-earth magnet has a nanocomposite microstructure including an Fe phase, a SmFeN phase, and an MeB phase. The SmFeN phase includes at least a Sm₂Fe₁₇Nₓ phase selected from the Sm₂Fe₁₇Nₓ phase and a SmFe₉N_{y} phase. The volume percentage of the SmFe₉N_{y} phase in the microstructure is 65% or less by volume. In the rare-earth magnet, the atomic percentage of the total content of the Me and B is 0.1 at % or more and 5.0 at % or less with respect to the total amount of Sm, Fe, the Me, and B, and the atomic percentage of Fe in all phases of compounds each containing at least one of the Me and B is 20 at % or less.

A method for producing a rare-earth magnet according to the present disclosure includes the following steps:

(A) a provision step of providing a Sm—Fe-Me-B-based alloy having a SmFe₉ structure serving as a main phase, the Sm—Fe-Me-B-based alloy containing an Me and B, by rapidly cooling a molten alloy containing Sm and Fe serving as main components, the Me and B being incorporated into the molten alloy;
(B) a hydrogenation-disproportionation step of subjecting the Sm—Fe-Me-B-based alloy to hydrogenation-disproportionation treatment by heat treatment in a hydrogen-containing atmosphere to decompose at least part of the Sm—Fe-Me-B-based alloy into a SmH₂ phase, an Fe phase, and an MeB phase through a disproportionation reaction;
(C) a formation step of pressure-forming the Sm—Fe-Me-B-based alloy that has been subjected to the hydrogenation-disproportionation treatment to provide a formed article;
(D) a desorption-recombination step of subjecting the formed article to desorption-recombination treatment by heat treatment in an inert atmosphere or a reduced-pressure atmosphere to allow the SmH₂ phase and the Fe phase provided by decomposition in the hydrogenation-disproportionation treatment to recombine through a recombination reaction; and
(E) a nitriding step of subjecting the formed article that has been subjected to the desorption-recombination treatment to nitriding treatment by heat treatment in a nitrogen-containing atmosphere.

The Me represents at least one element selected from elements in groups 4, 5, and 6 of the periodic table. In the provision step, the Me and B are incorporated such that the atomic percentage of the total content of the Me and B is 0.1 at % or more and 5.0 at % or less with respect to the total amount of Sm, Fe, the Me, and B and such that the atomic percentage of Fe in all phases of compounds each containing at least one of the Me and B, the compounds being formed in the hydrogenation-disproportionation treatment, is 20 at % or less. In the hydrogenation-disproportionation treatment, the volume percentage of the phase of the SmFe₉ structure in the Sm—Fe-Me-B-based alloy that has been subjected to the hydrogenation-disproportionation treatment is 65% or less by volume.

### BRIEF DESCRIPTION OF DRAWINGS

FIG. 1 is a schematic diagram of the crystalline microstructure of a Sm—Fe-based alloy after hydrogenation-disproportionation treatment in a method for producing a rare-earth magnet according to an embodiment.

FIG. 2 is a schematic diagram of the crystalline microstructure of a formed article after desorption-recombination treatment in a method for producing a rare-earth magnet according to an embodiment.

FIG. 3 is a schematic diagram of the crystalline microstructure of a rare-earth magnet after nitriding treatment in a method for producing a rare-earth magnet according to an embodiment.

### DESCRIPTION OF EMBODIMENTS

Examples of rare-earth magnets mainly used include sintered magnets each produced by sintering a rare-earth-iron-based alloy magnetic powder using pressure forming; and bonded magnets each produced by mixing a rare-earth-iron-based magnetic powder with a binder and subjecting the resulting mixture to pressure forming to cure the binder. In the case of Sm—Fe—N-based magnets, these are usually used in the form of bonded magnets (see PTL 1). The reason for this is as follows: when Sm—Fe—N-based compounds are sintered, the compounds are decomposed to fail to provide the performance of magnets because of their low decomposition temperatures.

A compacted magnet produced by subjecting a rare-earth-iron-based magnetic powder to pressure forming is reported (see PTL 2). In PTL 2, the rare-earth-iron-based powder serving as a raw material is subjected to hydrogenation-disproportionation (HD) treatment and then pressure forming to form a compact. The compact is subjected to desorption-recombination (DR) treatment and then nitriding treatment to produce a rare-earth magnet. According to the technique described in this literature, the hydrogenation-disproportionation treatment of the rare-earth-iron-based alloy improves formability, and the pressure forming of the alloy powder that has been subjected to the hydrogenation-disproportionation treatment provides a high-density compact, thus enabling an increase in the density of the rare-earth magnet.

Sm—Fe—N-based rare-earth magnets have been required to have higher performance. There has been a strong demand for the development of a rare-earth magnet having good magnetic properties.

The inventors have conducted intensive studies on an improvement in the magnetic properties of a Sm—Fe—N-based rare-earth magnet and have reached findings below.

In general, conventional Sm—Fe—N-based bonded magnets contain binders and thus have low relative density. Accordingly, percentages of Sm—Fe—N-based alloy magnetic powders therein are low, thus leading to degraded magnetic properties. The operating temperatures of the magnets are limited to the upper temperature limits of binders. Thus, the upper temperature limits of the magnets are disadvantageously low, limiting the range of use.

Because compacted magnets do not require any binder, the foregoing problems of bonded magnets can be solved by the use of the foregoing technique for a compacted magnet. In the method for producing a compacted Sm—Fe—N-based magnet, a Sm—Fe-based alloy powder serving as a raw material is subjected to hydrogenation-disproportionation treatment to decompose a Sm—Fe-based compound through a disproportionation reaction into two phases of SmH₂ and Fe, resulting in a mixed crystal microstructure including these phases. Accordingly, the presence of the Fe phase, which is softer than the Sm—Fe-based compound and SmH₂, results in an improvement in formability.

The inventors have developed conventional techniques for compacted magnets and have attempted to improve magnetic properties by the formation of a nanocomposite in order to produce a rare-earth magnet having higher performance. The formation of a nanocomposite refers to the formation of a nanocomposite microstructure including fine nano-sized soft and hard magnetic phases, both phases being combined together on the order of nanometers. An example of the soft magnetic phase is Fe. Examples of the hard magnetic phase include Sm—Fe-based compounds (e.g., Sm₂Fe₁₇N₃, and SmFe₉N_{1.8}). Owing to the formation of a nanocomposite, the soft magnetic phase is pinned to the hard magnetic phase by the exchange interaction between the soft magnetic phase and the hard magnetic phase, so that the soft and hard magnetic phases behave like a single-phase magnet.

Accordingly, the resulting nanocomposite has high magnetization arising from the soft magnetic phases and a high coercive force arising from the hard magnetic phases and thus has improved magnetic properties such as remanent magnetization and coercive force.

In magnets having a nanocomposite microstructure, a smaller grain size of an Fe phase to a certain extent results in higher exchange interaction and is markedly effective in improving the magnetic properties. However, in conventional compacted magnets, because the Fe phase has an average grain size of more than 300 nm, an improvement in magnetic properties by the formation of the nanocomposite is not sufficient, and there remains a need for improvement. Thus, if the Fe phase can be refined, the magnetic properties seem to be significantly improved to provide a compacted rare-earth magnet having high remanent magnetization and high coercive force.

The inventors have found that the addition of boron (B) in addition to a specific element can form a fine nanocomposite microstructure to provide a compacted rare-earth magnet having good magnetic properties. The present invention has been accomplished based on the foregoing findings. Embodiments according to the present disclosure are first listed and explained.

### 1. DESCRIPTION OF EMBODIMENTS

(1) A rare-earth magnet according to the present disclosure is a rare-earth magnet containing Sm, Fe, and N. The rare-earth magnet contains an Me and B serving as additive elements, the Me representing at least one element selected from elements in groups 4, 5, and 6 of the periodic table. The rare-earth magnet has a nanocomposite microstructure including an Fe phase, a SmFeN phase, and an MeB phase. The SmFeN phase includes at least a Sm₂Fe₁₇Nₓ phase selected from the Sm₂Fe₁₇Nₓ phase and a SmFe₉N_{y} phase. The volume percentage of the SmFe₉N_{y} phase in the microstructure is 65% or less by volume. In the rare-earth magnet, the atomic percentage of the total content of the Me and B is 0.1 at % or more and 5.0 at % or less with respect to the total amount of Sm, Fe, the Me, and B, and the atomic percentage of Fe in all phases of compounds each containing at least one of the Me and B is 20 at % or less.

Because the rare-earth magnet contains the Me and B serving as additive elements and has an Fe/SmFeN/MeB nanocomposite microstructure, the rare-earth magnet has high remanent magnetization and high coercive force and has good magnetic properties. The SmFeN phase is formed of a compound that contains Sm, Fe, and N and that exhibits hard magnetism. Specific examples thereof include a Sm₂Fe₁₇Nₓ phase and a SmFe₉N_{y} phase. The MeB phase is formed of a compound containing the Me and B (boride of the Me) and may contain solid solution Fe. The rare-earth magnet contains the Fe phase serving as a soft magnetic phase and the SmFeN phase serving as a hard magnetic phase. The dispersion of the fine Fe phase results in the exchange interaction between the soft magnetic phase and the hard magnetic phase to provide both high magnetization and high coercive force. The Fe phase has an average grain size of, for example, 50 nm or less. The atomic ratio x of N in Sm₂Fe₁₇Nₓ is, for example, 2.0≤x≤3.5, preferably x=3. The atomic ratio y of N in SmFe₉N_{y} is, for example, 0.5≤y≤2.0, preferably y=1.8.

The Me, which is an additive element, reacts with B to form the MeB phase that is effective in refining the microstructure in the hydrogenation-disproportionation treatment and effective in inhibiting the coarsening of the Fe phase in the desorption-recombination treatment, thereby contributing to the refinement of the Fe phase. Although details are described below, when the Sm—Fe-Me-B-based alloy, which is a raw material, is subjected to the hydrogenation-disproportionation treatment, the MeB phase is formed to refine the microstructure that has been subjected to phase decomposition. The refined microstructure that has been subjected to phase decomposition by the hydrogenation-disproportionation treatment results in the refinement of the microstructure recombined by the desorption-recombination treatment, leading to the refinement of the Fe phase. In particular, a larger difference in atomic radius between the Me and Fe seems to more easily provide the effect of refining the microstructure in the hydrogenation-disproportionation treatment. The MeB phase is effective in inhibiting the coarsening of the Fe phase formed in the recombination and thus is effective in further refining the Fe phase. The Me represents at least one element selected from elements in groups 4, 5, and 6 of the periodic table, is not easily hydrogenated in the hydrogenation-disproportionation treatment, and reacts preferentially with B to form the MeB phase. In the case of the foregoing element, even if Fe in the SmFeN phase (the Sm₂Fe₁₇Nₓ phase or the SmFe₉N_{y} phase), which is a hard magnetic phase, is partially replaced with the Me, the magnetic properties are seemingly less influenced.

Because the atomic percentage of the total content of the Me and B is 0.1 at % or more and 5.0 at % or less, both the refinement of the Fe phase and improvements in the magnetic properties can be achieved. When the atomic percentage of the total content of the Me and B is 0.1 at % or more, the MeB phase is sufficiently formed to sufficiently refine the Fe phase, providing the effect of significantly improving the magnetic properties. When the atomic percentage is 5.0 at % or less, the phases of compounds each containing at least one of the Me and B are reduced. The compounds are harder than the Fe phase and less likely to be deformed. Thus, the reduction of the phases of the compounds enhances the formability and increases the density to provide good magnetic properties. In the case where the atomic percentage of Fe in all the phases of the compounds each containing at least one of the Me and B is 20 at % or less, the percentage of Fe in the phases of the foregoing compounds is low; thus, the Fe phase is sufficiently present to enhance the formability and to increase the density. Examples of the compounds each containing at least one of the Me and B include a compound (MeB), constituting the MeB phase, of the Me and B, a compound (MeFe) of the Me and Fe, and a compound (FeB) of Fe and B. Regarding the MeB, the combination ratio of the Me to B is constant. When one of the Me and B is contained in an amount larger than the ratio, an MeFe phase or an FeB phase can be formed in addition to the MeB phase, as the phases of the foregoing compounds.

Because the volume percentage of the SmFe₉N_{y} phase in the microstructure is 65% or less by volume, improved formability is provided, and thus a magnet having a relative density of, for example, 75% or more can be produced. Although details are described below, a phase having an undecomposed SmFe₉ structure is left in the hydrogenation-disproportionation treatment of the Sm—Fe-Me-B-based alloy serving as a raw material, thereby forming the SmFe₉N_{y} phase. A lower percentage of the SmFe₉N_{y} phase results in a larger amount of the Fe phase formed by phase decomposition in the hydrogenation-disproportionation treatment, thereby improving the formability. When the SmFe₉N_{y} phase accounts for 65% or less by volume, the formability is easily enhanced, and a magnet having a high relative density and good magnetic properties is obtained. The volume percentage of the SmFe₉N_{y} phase may be zero.

(2) In an embodiment of the rare-earth magnet, the Me represents at least one element selected from Zr, Nb, and Ti.

Zr, Nb, and Ti are preferred because these seem to be less likely to affect the magnetic properties when incorporated.

Among these, Zr and Nb have a larger atomic radius than Fe. The percentage of the atomic radius of each of Zr and Nb with respect to the atomic radius of Fe is 120% or more. Thus, Zr and Nb seem to be highly effective in refining the microstructure that has been subjected to phase decomposition by the hydrogenation-disproportionation treatment. The percentage of the atomic radius of each of Zr and Nb with respect to the atomic radius of Fe is 140% or less. Thus, these seem to be less likely to affect the magnetic properties when incorporated. When the Me represents Zr, the MeB phase is typically a ZrB₂ phase. When the Me represents Nb, the MeB phase is a NbB₂ phase.

(3) In an embodiment of the rare-earth magnet, the Fe phase has an average grain size of 50 nm or less.

Because the Fe phase has an average grain size of 50 nm or less, the exchange interaction is enhanced to significantly improve the magnetic properties.

(4) In an embodiment of the rare-earth magnet, the rare-earth magnet has a relative density of 75% or more.

Because the rare-earth magnet has a relative density of 75% or more, the proportions of the magnetic phases serving as a magnet are high, thereby providing good magnetic properties.

(5) A method for producing a rare-earth magnet according to the present disclosure includes the following steps:
(A) a provision step of providing a Sm—Fe-Me-B-based alloy having a SmFe₉ structure serving as a main phase, the Sm—Fe-Me-B-based alloy containing an Me and B, by rapidly cooling a molten alloy containing Sm and Fe serving as main components, the Me and B being incorporated into the molten alloy;
(B) a hydrogenation-disproportionation step of subjecting the Sm—Fe-Me-B-based alloy to hydrogenation-disproportionation treatment by heat treatment in a hydrogen-containing atmosphere to decompose at least part of the Sm—Fe-Me-B-based alloy into a SmH₂ phase, an Fe phase, and an MeB phase through a disproportionation reaction;
(C) a formation step of pressure-forming the Sm—Fe-Me-B-based alloy that has been subjected to the hydrogenation-disproportionation treatment to provide a formed article;
(D) a desorption-recombination step of subjecting the formed article to desorption-recombination treatment by heat treatment in an inert atmosphere or a reduced-pressure atmosphere to allow the SmH₂ phase and the Fe phase provided by decomposition in the hydrogenation-disproportionation treatment to recombine through a recombination reaction; and
(E) a nitriding step of subjecting the formed article that has been subjected to the desorption-recombination treatment to nitriding treatment by heat treatment in a nitrogen-containing atmosphere,

The Me represents at least one element selected from elements in groups 4, 5, and 6 of the periodic table. In the provision step, the Me and B are incorporated such that the atomic percentage of the total content of the Me and B is 0.1 at % or more and 5.0 at % or less with respect to the total amount of Sm, Fe, the Me, and B and such that the atomic percentage of Fe in all phases of compounds each containing at least one of the Me and B, the compounds being formed in the hydrogenation-disproportionation treatment, is 20 at % or less. In the hydrogenation-disproportionation treatment, the volume percentage of the phase of the SmFe₉ structure in the Sm—Fe-Me-B-based alloy that has been subjected to the hydrogenation-disproportionation treatment is 65% or less by volume.

In the method for producing a rare-earth magnet, the Sm—Fe-Me-B-based alloy that serves as a raw material, that has the SmFe₉ structure serving as a main phase, and that contains the Me and B is subjected to the hydrogenation-disproportionation treatment, pressure forming, and desorption-recombination treatment to produce a binder-free, high-density rare-earth magnet. The incorporation of the Me and B forms the MeB phase in the hydrogenation-disproportionation treatment of the Sm—Fe-Me-B-based alloy serving as a raw material, thereby enabling the refinement of the microstructure that has been subjected to phase decomposition by the hydrogenation-disproportionation treatment. This results in the refinement of the microstructure recombined by the desorption-recombination treatment, thereby forming a fine nanocomposite microstructure. The MeB phase inhibits the coarsening of the Fe phase formed in the recombination to further refine the Fe phase. Accordingly, a rare-earth magnet having good magnetic properties can be produced by the method for producing a rare-earth magnet. The mechanism of the method for producing a rare-earth magnet will be described.

The Sm—Fe-Me-B-based alloy, which is a raw material, provided in the provision step is produced by the rapid cooling of the molten alloy containing Sm Fe serving as main components, the Me and B being incorporated into the molten alloy. The rapid cooling provides the SmFe₉ structure, which is a metastable structure and is more unstable than a Sm₂Fe₁₇ structure, thereby producing the Sm—Fe-Me-B-based alloy having the SmFe₉ structure serving as a main phase and containing the Me and B.

The Me, which is an additive element, represents at least one element selected from elements in groups 4, 5, and 6 of the periodic table. Examples thereof include Zr, Nb, and Ti. The amounts of the Me and B are such that the atomic percentage of the total content of the Me and B is 0.1 at % or more and 5.0 at % or less and such that the atomic percentage of Fe in all phases of compounds each containing at least one of the Me and B, the compounds being formed in the hydrogenation-disproportionation treatment, is 20 at % or less.

In the hydrogenation-disproportionation step, at least part of the Sm—Fe-Me-B-based alloy is decomposed by the hydrogenation-disproportionation treatment into the SmH₂ phase, the Fe phase, and the MeB phase to provide a hydrogenated alloy having a mixed crystal microstructure including these three phases. Here, in the case where the Sm—Fe-Me-B-based alloy is partially decomposed by the hydrogenation-disproportionation treatment, the phase of the undecomposed SmFe₉ structure is left, thus resulting in a microstructure including the SmFe₉ phase in addition to the foregoing three phases. The MeB phase is formed by the hydrogenation-disproportionation treatment. The MeB phase can block the movement of the SmH₂ phase to inhibit the coarsening of the SmH₂ phase due to the bonding of the SmH₂ phase grains together. Thus, the microstructure that has been subjected to phase decomposition by the hydrogenation-disproportionation treatment is seemingly refined. In particular, in the case where there is a large difference in atomic radius between the Me and Fe and where the percentage of the atomic radius of the Me with respect to the atomic radius of Fe is 120% or more, the MeFe phase is seemingly highly effective in blocking the movement of the SmH₂ phase in the hydrogenation-disproportionation treatment and thus is highly effective in refining the microstructure.

The Sm—Fe-Me-B-based alloy (hydrogenated alloy) that has been subjected to the hydrogenation-disproportionation treatment is pressure-formed in the formation step to provide a formed article. In the desorption-recombination step, the desorption-recombination treatment of the formed article allows the SmH₂ phase and the Fe phase provided by decomposition in the hydrogenation-disproportionation treatment to recombine, thereby providing a mixed crystal body having a nanocomposite microstructure including the Fe phase, the Sm₂Fe₁₇ phase, and the MeB phase. In the desorption-recombination step, the refined microstructure that has been subjected to phase decomposition by the hydrogenation-disproportionation treatment results in the refinement of the microstructure provided by recombination in the desorption-recombination treatment, leading to the refinement of the Fe phase. In the desorption-recombination treatment, the MeB phase is seemingly distributed at grain boundaries of the Sm₂Fe₁₇ phase to block the transfer of the Fe phase at the grain boundaries, the Fe phase being formed at the grain boundaries by the recombination. This seemingly inhibits the grain growth of the Fe phase due to the bonding of the Fe phase to inhibit the coarsening of the Fe phase. For example, the Fe phase can have an average grain size of 100 nm or less, even 50 nm or less. The formed article (mixed crystal body) that has been subjected to the desorption-recombination treatment is subjected to the nitriding treatment to nitride the Sm₂Fe₁₇ phase, thereby providing the rare-earth magnet having the nanocomposite microstructure including the Fe phase, the Sm₂Fe₁₇Nₓ phase, and the MeB phase. In the case where the SmFe₉ phase is present, the SmFe₉ phase is nitrided simultaneously with the Sm₂Fe₁₇ phase, thereby providing a microstructure including the SmFe₉N_{y} phase in addition to the three phases.

In the hydrogenation-disproportionation step, the volume percentage of the phase of the SmFe₉ structure in the Sm—Fe-Me-B-based alloy that has been subjected to the hydrogenation-disproportionation treatment is 65% or less by volume (including zero); thus, the Fe phase formed by phase decomposition in the hydrogenation-disproportionation treatment is increased to improve the formability. Accordingly, a higher density can be provided. For example, the magnet can have a relative density of 75% or more, even 77.5% or more.

(6) In an embodiment of the method for producing a rare-earth magnet, the method further includes a pulverization step of pulverizing the Sm—Fe-Me-B-based alloy before the formation step.

The pulverization of the Sm—Fe-Me-B-based alloy into a powder increases the flowability of the alloy when the alloy is charged into a die set in the formation step, thereby facilitating the charging operation. The pulverization step may be performed before the formation step. The Sm—Fe-Me-B-based alloy serving as a raw material may be pulverized. Alternatively, the Sm—Fe-Me-B-based alloy that has been subjected to the hydrogenation-disproportionation treatment may be pulverized. That is, the pulverization step is performed before or after the hydrogenation-disproportionation step.

(7) In an embodiment of the method for producing a rare-earth magnet, in the provision step, the Sm—Fe-Me-B-based alloy is produced by rapid cooling using a melt-spinning method.

Because the Sm—Fe-Me-B-based alloy is produced by rapid cooling using the melt-spinning method, the Sm—Fe-Me-B-based alloy having the SmFe₉ structure serving as a main phase and containing the Me and B can be industrially produced.

### 2. DETAIL OF EMBODIMENT

Specific embodiments of the rare-earth magnet and the method for producing a rare-earth magnet according to the present disclosure will be described below. Hereinafter, the method for producing a rare-earth magnet will first be described.

[2.-1 Method for Producing Rare-Earth Magnet]

The method for producing a rare-earth magnet according to an embodiment of the present disclosure includes the provision step of providing the Sm—Fe-Me-B-based alloy serving as a raw material, the hydrogenation-disproportionation step of subjecting the raw-material alloy to the hydrogenation-disproportionation treatment, the formation step of pressure-forming the raw-material alloy that has been hydrogenation-disproportionation treatment, the desorption-recombination step of subjecting the formed article obtained by pressure forming, and the nitriding step of subjecting the formed article that has been subjected to the desorption-recombination treatment to the nitriding treatment. The steps will be described in detail below.

[2.-1-1 Provision Step]

The provision step is a step of providing a Sm—Fe-Me-B-based alloy having a SmFe₉ structure serving as a main phase, the Sm—Fe-Me-B-based alloy containing an Me and B, by rapidly cooling a molten alloy containing Sm and Fe serving as main components, the Me and B being incorporated into the molten alloy. The term “main components” used here indicates that the total content of Sm and Fe accounts for 90 at % or more of the constituent elements of the Sm—Fe-Me-B-based alloy. The content of Sm is, for example, 5.0 at % or more and 11 at % or less.

[2.-1-2 Element Me]

The Me represents at least one element selected from elements in groups 4, 5, and 6 of the periodic table. Examples thereof include Zr, Nb, and Ti. When the elements in groups 4, 5, and 6 of the periodic table are subjected to the hydrogenation-disproportionation treatment in the hydrogenation-disproportionation step described below, the elements are less likely to be hydrogenated than Sm and react preferentially with B rather than Fe. When the Me represents an element selected from elements in groups 4, 5, and 6 of the periodic table, even if Fe of the SmFeN phase (the Sm₂Fe₁₇Nₓ phase or the SmFe₉N_{y} phase), which is a hard magnetic phase, is partially replaced with the Me, the magnetic properties are seemingly less influenced.

The Me reacts with B to form the MeB phase in the hydrogenation-disproportionation treatment of the Sm—Fe-Me-B-based alloy in the hydrogenation-disproportionation step described below. In the provision step, the Me and B are incorporated such that the atomic percentage of the total content of the Me and B is 0.1 at % or more and 5.0 at % or less with respect to the total amount of Sm, Fe, the Me, and B and such that the atomic percentage of Fe in all phases of compounds each containing at least one of the Me and B, the compounds being formed in the hydrogenation-disproportionation treatment, is 20 at % or less. When the Me represents Zr, the MeB phase is typically a ZrB₂ phase. When the Me represents Nb, the MeB phase is NbB₂ phase. Examples of the compounds each containing at least one of the Me and B include a compound (MeB), constituting the MeB phase, of the Me and B, a compound (MeFe) of the Me and Fe, and a compound (FeB) of Fe and B. Regarding the MeB, the combination ratio of the Me to B is constant. When one of the Me and B is contained in an amount larger than the ratio, an MeFe phase or an FeB phase can be formed in addition to the MeB phase, as the phases of the foregoing compounds. For example, in the case of ZrB₂, which is a compound of Zr and B, the combination ratio of Zr to B (Zr:B) chemically combined is 1:2 in terms of atomic ratio. When the amount of Zr is larger than the ratio, excess Zr reacts with Fe to form ZrFe. When the amount of B is larger than the ratio, FeB is formed. As described above, when one of the Me and B is contained in an amount that deviates from the combination ratio of MeB, MeFe or FeB is formed to increase the atomic percentage of Fe in the phases of the compounds. For example, when the combination ratio of MeB is 1:2, the Me and B are incorporated in such a manner that the content ratio of Me to B satisfies 0.75 to 1.5:1.5 to 2.25.

[2.-1-3 Production of Sm—Fe-Me-B-Based Alloy]

The Sm—Fe-Me-B-based alloy is an alloy obtained by rapidly cooling a molten alloy in which Sm, Fe, the Me, and B are mixed together so as to obtain the SmFe₉ structure. The rapid cooling provides the SmFe₉ structure, which is a metastable structure and is more unstable than the Sm₂Fe₁₇ structure, thereby producing the Sm—Fe-Me-B-based alloy having the SmFe₉ structure serving as a main phase and containing the Me. A higher cooling rate results in the inhibition of the precipitation of a-Fe and grain growth to provide a finer microstructure. The cooling rate is preferably 1×10⁶° C./s or more.

The foregoing Sm—Fe-Me-B-based alloy can be produced by rapid cooling using, for example, a melt-spinning method. The melt-spinning method is a rapid cooling method in which a jet of a molten alloy is fed onto a cooled metal drum, resulting in a thin-film-like or thin-strip-like alloy. The resulting alloy may be pulverized into a powder as described below. In the melt-spinning method, the cooling rate can be controlled by changing the peripheral speed of the drum. Specifically, a higher peripheral speed of the drum results in a smaller thickness of the alloy and a higher cooling rate. The peripheral speed of the drum is preferably 30 m/s or more, even 35 m/s or more, more preferably 40 m/s or more. In general, when the peripheral speed of the drum is 35 m/s or more, the alloy has a thickness of about 10 to about 20 μm, and the cooling rate can be controlled to 1×10⁶° C./s or more. The upper limit of the peripheral speed of the drum is, for example, 100 m/s or less in view of production. When the alloy rapidly cooled by the melt-spinning method has an excessively large thickness, the alloy is less likely to be uniform. Accordingly, the alloy preferably has a thickness of 10 μm or more and 20 μm or less.

[2.-1-4 Hydrogenation-Disproportionation Step]

The hydrogenation-disproportionation step is a step of subjecting the Sm—Fe-Me-B-based alloy to the hydrogenation-disproportionation treatment by the heat treatment in the hydrogen-containing atmosphere to decompose at least part of the Sm—Fe-Me-B-based alloy into the SmH₂ phase, the Fe phase, and the MeB phase through a disproportionation reaction with hydrogen. In this step, the hydrogenated alloy having the mixed crystal microstructure including the SmH₂ phase, the Fe phase, and the MeB phase is provided. In the hydrogenation-disproportionation treatment, the heat treatment is performed at a temperature equal to or higher than a temperature at which the disproportionation reaction of the Sm—Fe-Me-B-based alloy (SmFe₉ structural phase) with hydrogen occurs. The initiation temperature of the disproportionation reaction with hydrogen can be defined as follows: At room temperature (25° C.), a Sm—Fe-Me-B-based alloy sample is placed in a gastight container filled with hydrogen at an internal pressured of 0.8 to 1.0 atm (81.0 to 101.3 kPa). The temperature of the container is raised. The internal pressure when the temperature reaches 400° C. is expressed as P_{H2} (400° C.) [atm]. The minimum internal pressure in the temperature range of 400° C. to 900° C. is expressed as P_{H2} (MIN) [atm]. The difference between P_{H2} (400° C.) and P_{H2} (MIN) is expressed as ΔP_{H2} [atm]. The initiation temperature can be defined as a temperature in the range of 400° C. to 900° C. when the internal pressure is {P_{H2} (400° C.)−ΔP_{H2}×0.1} or less. If two or more temperatures fit the rule, the lowest temperature is defined as the initiation temperature. At this time, the weight of the sample is preferably set in such a manner that P_{H2} (MIN) is 0.5 atm (50.6 kPa) or less. A higher heat-treatment temperature in the hydrogenation-disproportionation treatment allows the phase decomposition of the Sm—Fe-Me-B-based alloy to further proceed. However, an excessively high heat-treatment temperature may result in the coarsening of the crystal phases constituting the microstructure. The preferred range of the heat-treatment temperature (hydrogenation-disproportionation temperature) in the hydrogenation-disproportionation treatment varies depending on the type of the Me and is, for example, 550° C. or higher and 650° C. or lower.

Here, when part of the Sm—Fe-Me-B-based alloy is subjected to phase decomposition by the hydrogenation-disproportionation treatment, a phase having an undecomposed SmFe₉ structure is left, thereby resulting in a microstructure including the SmFe₉ phase in addition to the foregoing three phases.

In this case, the use of a hydrogenation-disproportionation temperature lower than a temperature at which P_{H2} (MIN) is obtained facilitates the phase decomposition of only part of the Sm—Fe-Me-B-based alloy.

The time of the hydrogenation-disproportionation treatment may be appropriately set and is, for example, 30 minutes or more and 180 minutes or less. An insufficient time of the hydrogenation-disproportionation treatment may result in the failure of the Sm—Fe-Me-B-based alloy to undergo sufficient phase decomposition. An excessively long time of the hydrogenation-disproportionation treatment may result in an excessive progress of the phase decomposition to coarsen the crystalline microstructure. Different times of the hydrogenation-disproportionation treatment also results in different proportions of the phase decomposition; thus, the microstructure of the hydrogenated alloy can be controlled.

Examples of the hydrogen-containing atmosphere include a H₂ gas atmosphere and mixed gas atmospheres each containing H₂ gas and an inert gas such as Ar or N₂. The atmosphere pressure (hydrogen partial pressure) of the hydrogen-containing atmosphere is, for example, 20.2 kPa (0.2 atm) or more and 1,013 kPa (10 atm) or less.

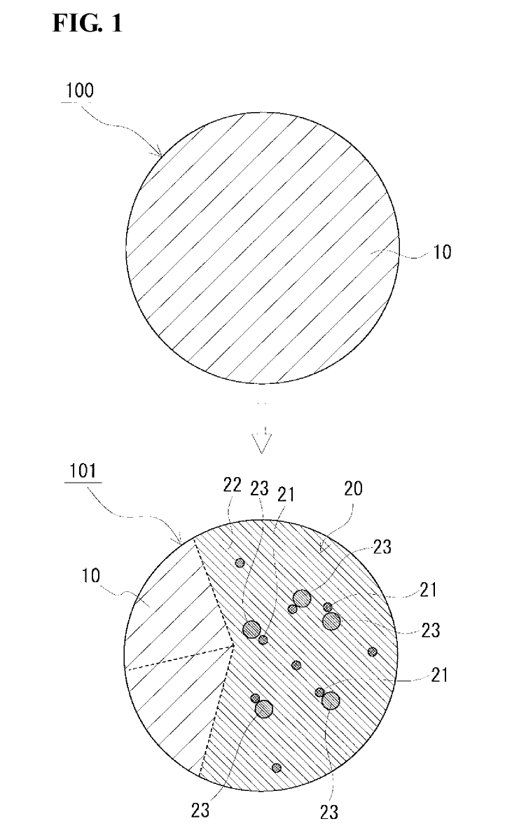

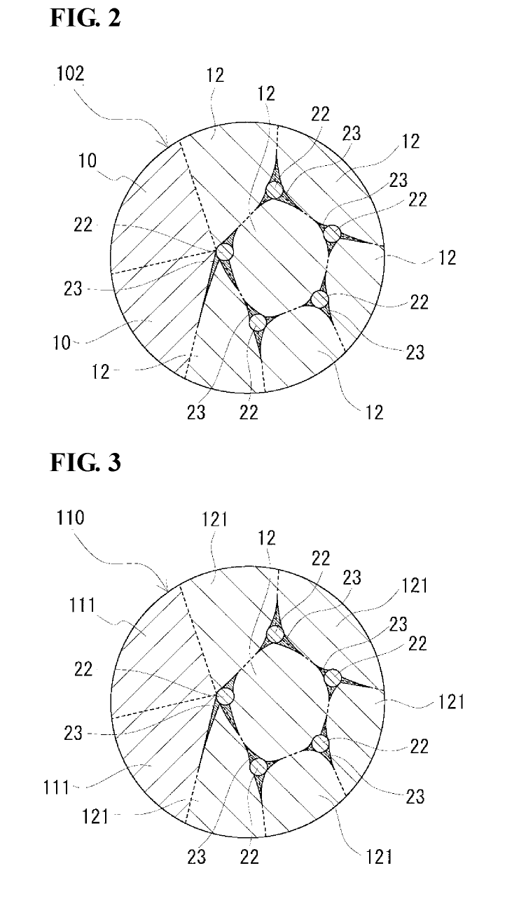

The crystalline microstructure of the Sm—Fe-Me-B-based alloy (hydrogenated alloy) after the hydrogenation-disproportionation treatment is described with reference to FIG. 1. A Sm—Fe-Me-B-based alloy 100 serving as a raw material, illustrated at the top of FIG. 1, is subjected to the hydrogenation-disproportionation treatment to subject a SmFe₉ structure phase 10 to hydrogenolysis into the SmH₂ phase, the Fe phase, and the MeB phase, thereby forming a microstructure including a mixed crystal region 20 that includes a SmH₂ phase 21, an Fe phase 22, and an MeB phase 23, as illustrated at the bottom of FIG. 1. Here, the figure illustrates the case where part of the Sm—Fe-Me-B-based alloy 100 (the SmFe₉ structure phase 10) is subjected to phase decomposition. The undecomposed SmFe₉ structure phase 10 is left, resulting in a multi-phase microstructure having the region of the SmFe₉ structure phase 10 and the mixed crystal region 20. In FIG. 1, for easy understanding, each of the phases constituting the microstructure is hatched (the same is true in FIGS. 2 and 3 described below). A hydrogenated alloy 101 thus obtained is easily plastically deformed and has improved formability owing to the presence of the Fe phase 22, which is softer than the SmFe₉ structure phase 10, the SmH₂ phase 21, and the MeB phase 23. Accordingly, a high-density formed article can be obtained in the formation step described below.

The formation of the MeB phase 23 by the hydrogenation-disproportionation treatment refines the microstructure that has been subjected to phase decomposition by the hydrogenation-disproportionation treatment. Specifically, the MeB phase 23 precipitated in the hydrogenation-disproportionation treatment blocks the movement of the SmH₂ phase 21 to inhibit the coarsening of the SmH₂ phase 21 due to the bonding of grains of the SmH₂ phase 21, thereby resulting in the SmH₂ phase 21 in a finely dispersed state. The effect of the MeB phase on the blocking of the movement of the SmH₂ phase 21 is easily provided when the difference in atomic radius between the Me and Fe is large. When the percentage of the atomic radius of the Me with respect to the atomic radius of is 120% or more, the effect of refining the microstructure is seemingly high.

Examples of the Me in which the percentage of the atomic radius thereof with respect to the atomic radius of Fe is 120% or more include Zr and Nb. The SmH₂ phase 21 has an average grain size of, for example, 5 nm or more and 15 nm or less, preferably 10 nm or less. The refined microstructure that has been subjected to phase decomposition by the hydrogenation-disproportionation treatment results in the refinement of the microstructure provided by recombination in the desorption-recombination treatment in the desorption-recombination step described below, leading to the refinement of the Fe phase.

In the case where the atomic percentage of the total content of the Me and B is 0.1 at % or more, the MeB phase is sufficiently formed, the coarsening of the SmH₂ phase 21 can be inhibited, and the microstructure that has been subjected to phase decomposition can be sufficiently refined. In the case where the atomic percentage is 5.0 at % or less, the phases of compounds each containing at least one of the Me and B are reduced, thus enhancing the formability. In the case where the atomic percentage of Fe in the phases of the compounds each containing at least one of the Me and B is 20 at % or less, the percentage of Fe in the phases of the foregoing compounds is low; thus, the Fe phase is increased to sufficiently enhance the formability. In the hydrogenated alloy 101, the volume percentage of the MeB phase 23 in the microstructure is preferably more than 0 and less than 5.0% by volume.

In the case where only part of the Sm—Fe-Me-B-based alloy 100 (SmFe₉ structure phase 10) serving as a raw material is subjected to phase decomposition, the mixed crystal region 20 is reduced in size, compared with the case where the whole of the Sm—Fe-Me-B-based alloy 100 is subjected to phase decomposition. Accordingly, when the SmH₂ phase 21 and the Fe phase 22 provided by phase decomposition in the hydrogenation-disproportionation treatment recombine in the desorption-recombination treatment in the desorption-recombination step described below, the formation of a coarse Fe phase is inhibited, thereby facilitating the formation of a finer microstructure.

The volume percentage of the SmFe₉ structure phase 10 in the Sm—Fe-Me-B-based alloy 100 that has been subjected to the hydrogenation-disproportionation treatment is 0 or more and 65% or less by volume. This results in an increase in the percentage of the mixed crystal region 20 formed by the phase decomposition of the SmFe₉ structure phase 10 to increase the Fe phase 22, leading to improved formability. When the volume percentage of the SmFe₉ structure phase 10 is more than 65% by mass, the percentage of the undecomposed SmFe₉ structure phase 10 is increased; thus, the resulting alloy is not easily plastically deformed to degrade the formability. When the whole of the Sm—Fe-Me-B-based alloy 100 is subjected to phase decomposition by the hydrogenation-disproportionation treatment, the volume percentage of the SmFe₉ structure phase 10 is zero. When part of the Sm—Fe-Me-B-based alloy 100 is subjected to phase decomposition, the volume percentage of the SmFe₉ structure phase 10 is, for example, 30% or more by volume.

The volume percentage of the SmFe₉ structure phase in the Sm—Fe-Me-B-based alloy after the hydrogenation-disproportionation treatment can be determined as follows: The microstructure of a section of the alloy is observed with a scanning electron microscope (SEM) and subjected to composition analysis with an energy dispersive X-ray spectrometer (EDX) to separate and extract the phases constituting the microstructure (for example, the SmFe₉ phase, the SmH₂ phase, the Fe phase, and the MeB phase). Here, when the phases, other than the MeB phase, (for example, the MeFe phase and the FeB phase) of compounds each containing at least one of the Me and B are present, the phases are also separated and extracted. The area percentage of the SmFe₉ phase in the field of view is determined. The volume percentage can be determined by regarding the resulting area percentage of the phase as the volume percentage. The composition analysis may be performed with an appropriate analyzer other than the EDX. The average grain size of the SmH₂ phase can be determined by measuring the circle-equivalent diameters of grains of the SmH₂ phase in the field of view and calculating the average value.

[2.-1-5 Formation Step]

The formation step is a step of pressure-forming the Sm—Fe-Me-B-based alloy (hydrogenated alloy) that has been subjected to the hydrogenation-disproportionation treatment to provide a formed article. Specifically, the hydrogenated alloy is charged into a die set and pressure-formed with a pressing machine. The forming pressure in the pressure forming is, for example, 294 MPa (3 ton/cm²) or more and 1,960 MPa (20 ton/cm²) or less.

The forming pressure is more preferably 588 MPa (6 ton/cm²) or more. The formed article preferably has a relative density of, for example, 75% or more. The upper limit of the relative density of the formed article is, for example, 95% or less in view of production. In the case where the pressure forming is performed, the application of a lubricant in advance on the internal surfaces of the die set facilitates the removal of the formed article from the die set. The term “relative density” used here refers to the actual density with respect to the true density (the percentage of [the actually measured density of the formed article/the true density of the formed article]). The true density is defined as the density of the Sm—Fe-Me-B-based alloy serving as a raw material.

[2.-1-6 Pulverization Step]

The pulverization step of pulverizing the Sm—Fe-Me-B-based alloy may be included before the formation step. The pulverization of the Sm—Fe-Me-B-based alloy into a powder facilitates the charging operation of charging the alloy into the die set in the formation step. The pulverization step is performed before or after the hydrogenation-disproportionation step. The Sm—Fe-Me-B-based alloy serving as a raw material may be pulverized. Alternatively, the hydrogenated alloy may be pulverized. The pulverization is preferably performed in such a manner that the alloy powder has a particle size of, for example, 5 mm or less, even 500 μm or less, particularly 300 μm or less. The pulverization may be performed with a known pulverizer such as a jet mill, a ball mill, a hammer mill, a braun mill, a pin mill, a disc mill, or a jaw crusher. When the alloy powder has a particle size of 10 μm or less, the filling properties of the alloy powder into the die set are degraded, and the influence of oxidation on the alloy powder is increased in the formation step; thus, the alloy powder preferably has a particle size of 10 μm or more. An atmosphere used in the pulverization is preferably an inert atmosphere in order to inhibit the oxidation of the alloy powder. An oxygen concentration in the atmosphere is preferably 5% or less by volume, even 1% or less by volume. Examples of the inert atmosphere include atmospheres of inert gases such as Ar and Nz.

[2.-1-7 Desorption-Recombination Step]

The desorption-recombination step is a step of subjecting the formed article composed of the Sm—Fe-Me-B-based alloy (hydrogenated alloy) that has been subjected to the hydrogenation-disproportionation treatment to the desorption-recombination treatment by heat treatment in an inert atmosphere or a reduced-pressure atmosphere to allow the SmH₂ phase and the Fe phase provided by decomposition in the hydrogenation-disproportionation treatment to recombine into the Sm₂Fe₁₇ phase through a recombination reaction.

In this step, a mixed crystal body having a nanocomposite microstructure including the Fe phase, the Sm₂Fe₁₇ phase, and the MeB phase is provided. In the desorption-recombination treatment, the heat treatment is performed at a temperature equal to or higher than a temperature at which the recombination reaction of the SmH₂ phase and the Fe phase provided by phase decomposition in the hydrogenation-disproportionation treatment occurs. The heat-treatment temperature (desorption-recombination temperature) in the desorption-recombination treatment is preferably such that SmH₂ is not detected (substantially no SmH₂ is present) in the central portion of the formed article (a portion most distant from the outer surface of the formed article). For example, the heat-treatment temperature is 600° C. or higher and 1,000° C. or lower. A higher heat-treatment temperature in the desorption-recombination treatment allows the recombination reaction to further proceed. However, an excessively high heat-treatment temperature may result in the coarsening of the crystalline microstructure. The heat-treatment temperature in the desorption-recombination treatment is more preferably 650° C. or higher and 800° C. or lower.

The time of the desorption-recombination treatment may be appropriately set and is, for example, 30 minutes or more and 180 minutes or less. An insufficient time of the desorption-recombination treatment may result in the failure of the recombination reaction to proceed sufficiently to the inside of the formed article. An excessively long time of the desorption-recombination treatment may result in the coarsening of the crystalline microstructure.

As the inert atmosphere, for example, an inert gas atmosphere such as Ar or N₂ is used. As the reduced-pressure atmosphere, for example, a vacuum atmosphere having a degree of vacuum of 10 Pa or less is used. More preferably, the degree of vacuum of the vacuum atmosphere is 1 Pa or less, even 0.1 Pa or less. In particular, when the desorption-recombination treatment is performed in the reduced-pressure atmosphere (vacuum atmosphere), the recombination reaction proceeds easily, so that the SmH₂ phase is not easily left. In the case where the formed article has a high density or a large size, if the pressure is rapidly reduced to 10 Pa or less in the desorption-recombination treatment in the vacuum atmosphere, the reaction may proceed only on surface layers of the formed article to cause the surface layers to shrink, thereby possibly closing voids to impede hydrogen release from the inside of the formed article. Accordingly, when the desorption-recombination treatment is performed in the vacuum atmosphere, the degree of vacuum is preferably controlled. For example, the degree of vacuum is preferably controlled as follows: The temperature is raised to a desorption-recombination temperature in the hydrogen-containing atmosphere at a pressure of 20 to 101 kPa. Then the pressure of the hydrogen-containing atmosphere is reduced to a degree of vacuum of, for example, about 0.1 to about 20 kPa. Ultimately, the degree of vacuum is 10 Pa or less. The same is true for the case where the alloy powder constituting the formed article has a large particle size.

The crystalline microstructure of the formed article (mixed crystal body) after the desorption-recombination treatment is described with reference to FIG. 2. The desorption-recombination treatment of the hydrogenated alloy 101 illustrated at the bottom of FIG. 1 recombines the SmH₂ phase 21 and the Fe phase 22 together in the mixed crystal region 20 to form the nanocomposite microstructure including the Fe phase 22, a Sm₂Fe₁₇ phase 12, and the MeB phase 23 as illustrated in FIG. 2. Because the undecomposed SmFe₉ structure phase 10 is left in the hydrogenated alloy 101, the SmFe₉ structure phase 10 is present in a mixed crystal body 102. Accordingly, the resulting mixed crystal body 102 has a microstructure including the SmFe₉ phase. In the SmFe₉ structure phase 10, an excessive Fe phase can be dispersedly precipitated in the SmFe₉ crystal in the desorption-recombination treatment. Here the refined microstructure that has been subjected to phase decomposition by the hydrogenation-disproportionation treatment results in the refinement of the microstructure provided by recombination in the desorption-recombination treatment, leading to the refinement of the Fe phase. The reason for this is presumably that the finely dispersed SmH₂ phase 21 (see the bottom of FIG. 1) results in the refinement of the Sm₂Fe₁₇ phase 12 in the recombination. When the SmH₂ phase 21 and the Fe phase 22 recombine to form the Sm₂Fe₁₇ phase 12, an excessive Fe component precipitates at grain boundaries of the Sm₂Fe₁₇ phase 12 to form the Fe phase 22. When the Sm₂Fe₁₇ phase 12 is fine, the amount of the excessive Fe component precipitating at the grain boundaries is small, thus leading to the refinement of the Fe phase 22. Accordingly, the refined Sm₂Fe₁₇ phase 12 results in the refinement of the Fe phase 22 in the microstructure provided by the recombination. The Fe phase 22 formed by the recombination tends to be easily distributed at the triple points of the grain boundaries of the Sm₂Fe₁₇ phase 12.

The MeB phase 23 is distributed along the grain boundaries of the Sm₂Fe₁₇ phase 12 in the desorption-recombination treatment and functions to block the transfer of the Fe phase 22 to inhibit the grain growth of the Fe phase 22 due to the bonding of the Fe phase 22, thus seemingly inhibiting the coarsening of the Fe phase 22.

[2.-1-8 Nitriding Step]

The nitriding step is a step of subjecting the formed article (mixed crystal body) that has been subjected to the desorption-recombination treatment to nitriding treatment by heat treatment in a nitrogen-containing atmosphere. In this step, the Sm₂Fe₁₇ phase included in the mixed crystal body is nitrided to provide a compacted rare-earth magnet having a nanocomposite microstructure including the Fe phase, the Sm₂Fe₁₇Nₓ phase, and the MeB phase. In the case where the mixed crystal body after the desorption-recombination treatment includes the SmFe₉ phase, the SmFe₉ phase is also nitrided to provide a microstructure including the SmFe₉N_{y} phase. The heat-treatment temperature in the nitriding treatment is, for example, 200° C. or higher and 550° C. or lower. A higher heat-treatment temperature in the nitriding treatment allows nitriding to further proceed. However, an excessively high heat-treatment temperature may result in the coarsening of the crystalline microstructure and excessive nitriding to degrade the magnetic properties. The heat-treatment temperature in the nitriding treatment is more preferably 300° C. or higher and 500° C. or lower. The time of the nitriding treatment may be appropriately set and is, for example, 60 minutes or more and 1,200 minutes or less.

Examples of the nitrogen-containing atmosphere include an NH₃ gas atmosphere, a mixed-gas atmosphere of NH₃ gas and H₂ gas, a N₂ gas atmosphere, and a mixed-gas atmosphere of N₂ gas and H₂ gas.

The crystalline microstructure of the rare-earth magnet after the nitriding treatment is described with reference to FIG. 3. The nitriding treatment of the mixed crystal body 102 illustrated in FIG. 2 nitrides the Sm₂Fe₁₇ phase 12 to form the nanocomposite microstructure including the Fe phase 22, a Sm₂Fe₁₇Nₓ phase 121, and the MeB phase 23 as illustrated in FIG. 3. When the mixed crystal body 102 includes the SmFe₉ structure phase 10, the SmFe₉ phase is also nitrided to provide a microstructure including a SmFe₉N_{y} phase 111. Fe in the Sm₂Fe₁₇Nₓ phase 121 and the SmFe₉N_{y} phase 111 may be partially replaced with the Me.

In the case where the Me represents an element selected from elements in groups 4, 5, and 6 of the periodic table, even if Fe is partially replaced with the Me, the magnetic properties are seemingly less influenced. In the resulting rare-earth magnet 110, the atomic ratio x of N in the Sm₂Fe₁₇Nₓ phase 121 is, for example, 2.0≤x≤3.5, preferably x=3. The atomic ratio y of N in the SmFe₉N_{y} phase 111 is, for example, 0.5≤y≤2.0, preferably y=1.8. The Fe phase 22 has an average grain size of 100 nm or less, preferably 50 nm or less, more preferably 45 nm or less. The average grain size of the Fe phase can be determined by direct observation with a transmission electron microscope (TEM). In addition, the average grain size can be determined by the Scherrer equation using the full width at half maximum of a diffraction peak obtained by X-ray diffraction. Furthermore, the average grain size can be determined as a dispersed particle size by an indirect method using an X-ray diffraction peak at a very low angle.

In the crystalline microstructure of the rare-earth magnet, the following two types of Fe phases can be present: an Fe phase precipitated as an excess component at grain boundary portions of Sm₂Fe₁₇ crystals when the SmH₂ phase and the Fe phase formed by the disproportionation reaction with hydrogen in the hydrogenation-disproportionation treatment recombine in the desorption-recombination treatment into the Sm₂Fe₁₇ phase; and an Fe phase in which excess Fe in the remaining SmFe_{9+α} phase undecomposed in the hydrogenation-disproportionation treatment is precipitated by pyrolysis in the SmFe₉ crystals. In the case where the heat-treatment temperature of each of the hydrogenation-disproportionation treatment and the desorption-recombination treatment is 700° C. or lower, the size of the former Fe phase tends to be larger than that of the latter Fe phase. The former Fe phase tends to have an odd shape, whereas the latter Fe phase tends to have a spherical shape. The former Fe phase and the latter Fe phase can be distinguished from each other by evaluating the roundness of the Fe phases through the observation of the microstructure. The term “roundness” used here refers to a value obtained by dividing a circular-equivalent diameter by a maximum diameter.

[2.-2 Rare-Earth Magnet]

The rare-earth magnet according to the present disclosure can be produced by the production method described above and has the nanocomposite microstructure including the Fe phase, the SmFeN phase, and the MeB phase. The SmFeN phase includes at least the Sm₂Fe₁₇Nₓ phase selected from the Sm₂Fe₁₇Nₓ phase and the SmFe₉N_{y} phase. As described above, in the case where the undecomposed SmFe₉ structure phase is left in the hydrogenation-disproportionation treatment of the Sm—Fe-Me-B-based alloy serving as a raw material in the production process, the microstructure includes the SmFe₉N_{y} phase. The rare-earth magnet is a compacted Sm—Fe-Me-N—B-based alloy magnet having an Fe/SmFeN/MeB nanocomposite mixed crystal microstructure. The rare-earth magnet includes the Fe phase serving as a soft magnetic phase and the SmFeN phases (the Sm₂Fe₁₇Nₓ phase (x=2.0 to 3.5) and the SmFe₉N_{y} phase (y=0.5 to 2.0)) serving as hard magnetic phases. The dispersion of the fine nano-sized (100 nm or less) Fe phase results in the exchange interaction between the soft magnetic phase and the hard magnetic phases to allow the rare-earth magnet to have both high magnetization and high coercive force. Because the rare-earth magnet has no binder, the percentages of the magnetic phases serving as a magnet are high, thereby providing performance close to intrinsic magnetic properties.

The volume percentage of the SmFe₉N_{y} phase in the microstructure is substantially equal to the volume percentage of the SmFe₉ structure phase in the Sm—Fe-Me-B-based alloy that has been hydrogenation-disproportionation treatment in the production process, and is 0 or more and 65% or less by volume. Similarly, the volume percentage of the MeB phase in the microstructure is substantially equal to the volume percentage of the MeB phase in the Sm—Fe-Me-B-based alloy that has been hydrogenation-disproportionation treatment, and is preferably more than 0 and less than 5.0% by volume. The volume percentage of the SmFe₉N_{y} phase and the MeB phase can be determined as follows: The microstructure of a section is observed with a SEM and subjected to composition analysis with an EDX. The area percentage of the target phase in the field of view is determined. The volume percentage can be determined by regarding the resulting area percentage of the phase as the volume percentage. In the case where the fine phases are precipitated, the microstructure may be appropriately observed with a TEM.

The Fe phase has an average grain size of 50 nm or less, preferably 45 nm or less. The fine Fe phase enhances the exchange interaction to provide significantly improved magnetic properties. The relative density is preferably 75% or more. In this case, the percentages of the magnetic phases serving as a magnet are high, thereby providing good magnetic properties. The relative density of the magnet is substantially equal to the relative density of the formed article before the desorption-recombination treatment and the nitriding treatment.

[2.-2-1 Magnetic Properties]

The rare-earth magnet has high remanent magnetization and high coercive force and has good magnetic properties.

For example, the remanent magnetization is 0.80 T or more, and the coercive force is 1,000 kA/m or more. The remanent magnetization is preferably 0.82 T or more, and the coercive force is preferably 1,100 kA/m or more.

### Test Example 1

Samples of rare-earth magnets (Nos. 1-1 to 1-10 and 1-21) listed in Table 1 were produced with Sm—Fe-Me-B-based alloys serving as starting materials, each containing an Me and B incorporated, serving as additive elements, and were evaluated.

In test example 1, Zr or Nb was used as the Me serving as the additive element. A molten alloy containing Sm and the Me and B serving as the additive elements, the balance being Fe and incidental impurities, was rapidly cooled by a melt-spinning method to produce a Sm—Fe-Me-B-based alloy having a SmFe₉ structure as a main phase and containing the Me and B. The resulting Sm—Fe-Me-B-based alloy was pulverized in an inert atmosphere and then screened into a Sm—Fe-Me-B-based alloy powder having a particle size of 106 nm or less. In sample Nos. 1-1 to 1-10, Zr was used as the Me. In sample No. 1-21, Nb was used. In each sample, the Me and B were added in amounts presented in Table 1, and the raw material composition was adjusted in such a manner that the content of Sm was 9.5 at %, the balance being Fe. When the Sm—Fe-Me-B-based alloy was produced by the melt-spinning method, the peripheral speed of a drum was set at 40 m/s.

The crystal structures of the Sm—Fe-Me-B-based alloys serving as the raw materials of the samples were studied by X-ray diffraction with an X-ray diffractometer (SmartLab, available from Rigaku Corporation). The results indicated that in each sample, diffraction peaks arising from a SmFe₉ structure were observed and thus each sample had the SmFe₉ structure.

Each of the provided Sm—Fe-Me-B-based alloy powders was subjected to hydrogenation-disproportionation treatment in a H₂ gas atmosphere (atmospheric pressure) to provide a hydrogenated alloy powder. In the hydrogenation-disproportionation treatment, the heat-treatment temperature was 575° C., and the treatment time was 150 minutes. In each hydrogenated alloy powder, the volume percentage of the SmFe₉ structure phase (SmFe₉ phase) was determined by observation of the microstructures of sections of the particles thereof with a SEM and by composition analysis with an EDX. Here, 10 or more particle sections were observed with a SEM-EDX instrument (JSM-7600F, available from JEOL, Ltd). The area percentage of the SmFe₉ phase in each particle was determined. The average value thereof was regarded as the volume percentage of the SmFe₉ phase. Table 1 lists the volume percentage of the SmFe₉ phase in each hydrogenated alloy powder. Regarding each of the hydrogenated alloy powders of sample Nos. 1-4 (Zr: 1.0+B: 2.0 (at %)) and 1-21 (Nb: 1.0+B: 2.0 (at %)), the circular-equivalent diameter of the SmH₂ phase in the field of view was measured to determine the average grain size of the SmH₂ phase. The results indicated that the SmH₂ phase had an average grain size of 12 nm in sample No. 1-4 and 9 nm in sample No. 1-21.

Each of the hydrogenated alloy powders was charged into a die set and pressure-formed to provide a cylindrical hydrogenated alloy powder compact having a diameter of 10 mm and a height of 10 mm. The pressure forming was performed at a forming pressure of 1,470 MPa (15 ton/cm²) at room temperature. A lubricant (myristic acid) was applied to inner surfaces of the die set.

The temperature of each of the resulting compacts was raised in a H₂ gas atmosphere (atmospheric pressure). After the temperature reached a predetermined desorption-recombination temperature, the atmosphere was switched to a vacuum atmosphere (with a degree of vacuum of 10 Pa or less) to perform desorption-recombination treatment, thereby providing a mixed crystal body. The desorption-recombination treatment was performed at a heat-treatment temperature of 650° C. for a treatment time of 150 minutes. Then the resulting compacts were subjected to nitriding treatment in a mixed gas atmosphere of NH₃ gas and H₂ gas (the volume mixing ratio of NH₃ gas to H₂ gas was 1:2) to provide samples (Nos. 1-1 to 1-10 and 1-21) of compacted rare-earth magnets listed in Table 1. The nitriding treatment was performed at a heat-treatment temperature of 350° C. for a treatment time of 720 minutes. Observation and composition analysis of the microstructures of sections of the resulting compacted magnets with the SEM-EDX instrument indicated that nanocomposite microstructures including Fe/Sm₂Fe₁₇Nₓ (x=2.0 to 3.5)/SmFe₉N_{y} (y=0.5 to 2.0)/MeB phases were formed.

(Sample No. 100)

A Sm—Fe-based alloy was produced in the same way as above, except that neither Me nor B was added as an additive element. A sample (No. 100) of a compacted rare-earth magnet was produced by using the resulting alloy as a starting material under the same production conditions. Also in the case of sample No. 100, after the Sm—Fe-based alloy powder serving as a raw material was subjected to hydrogenation-disproportionation treatment, the volume percentage of the SmFe₉ phase in the resulting hydrogenated alloy powder was similarly determined. Table 1 lists the results. The average grain size of the SmH₂ phase in the hydrogenated alloy powder of sample No. 100 was determined and found to be 60 nm.

(Sample Nos. 110 and 120)

Sm—Fe-Me-based alloys were produced in the same way as above, except that Zr or Nb alone was added as the additive element Me and that B was not added. Samples (Nos. 110 and 120) of compacted rare-earth magnets were produced by using the resulting alloys as starting materials under the same production conditions. Also in the cases of these samples, after the Sm—Fe-Me-based alloy powders serving as raw materials were subjected to the hydrogenation-disproportionation treatment, the volume percentage of the SmFe₉ phase in each of the resulting hydrogenated alloy powders was similarly determined. Table 1 lists the results. The average grain sizes of the SmH₂ phase in the hydrogenated alloy powders of sample Nos. 110 and 120 were determined and found to be 20 nm in sample No. 110 and 15 nm in sample No. 120.

Comparisons of the average grain sizes of the SmH₂ phase in the hydrogenated alloys of the samples indicated that the addition of B in addition to the Me inhibited the coarsening of the SmH₂ phase to provide the finer SmH₂ phase.

Observation and composition analysis of microstructures of sections of the resulting magnet samples were performed with the SEM-EDX instrument to study all types of phases of compounds each containing at least one of the Me and B (hereinafter, referred to as a “Me/B phase”). Table 1 lists the types of Me/B phase detected. The volume percentage of the Me/B phase in each of the microstructures was determined. The volume percentage of the Me/B phase was determined as follows: 10 or more fields of view of each section were observed with the SEM-EDX instrument. The total area percentage of all the Me/B phases in each field of view was determined. The average value thereof was regarded as the volume percentage. Table 1 lists the results. From the results of the composition analysis of the Me/B phase, the atomic percentage of Fe in all the Me/B phases was determined. Table 1 lists the type of Me/B phase, the volume percentage of the Me/B phase, and the atomic percentage of Fe in the Me/B phase of each sample. In sample No. 1-1, no Me/B phase was detected in the microstructure.

The relative density of the magnet of each of the resulting samples was determined. The relative density of the magnet was calculated by measuring the volume and the mass of the magnet, determining a measured density from these values, and regarding the density of the raw-material alloy as the true density. Table 1 lists the results. The magnet of each sample was subjected to X-ray diffraction. The average grain size of the Fe phase was determined from the Scherrer equation using the full width at half maximum of a diffraction peak. Table 1 lists the results.

The magnetic properties of the magnet of each sample were evaluated. Specifically, magnetization treatment was performed by the application of a pulsed magnetic field of 4,777 kA/m (5 T) with a magnetizer (Model SR, high-voltage capacitor type, available from Nihon Denji Sokki Co., Ltd). A B-H curve was measured with a BH tracer (DCBH tracer, available from Riken Denshi Co., Ltd.) to determine the saturation magnetization, the remanent magnetization, and the coercive force. The saturation magnetization was a value when a magnetic field of 2,388 kA/m was applied. Table 1 lists the saturation magnetization, the remanent magnetization, and the coercive force of each sample.

TABLE 1

| | | | Hydrogenated alloy | | Magnet | | | | | | | |
|---|---|---|---|---|---|---|---|---|---|---|---|---|
| | | | Hydrogen- | Volume | | Volume | | | | | | |
| | Material alloy | | ation- | percentage | | percentage | | | | | | |
| | | Amount | dispropor- | of | | of | Percentage | | Grain | | | |
| | Type | of | tionation | SmFe₉ | Type | Me/B | of Fe in | Relative | size | Saturation | Remanent | |
| | of | Me + B | temper- | phase | of | phase | Me/B | density | of Fe | magnet- | magnet- | Coercive |
| Sample | additive | added | ature | % by | Me/B | % by | phase | % by | phase | ization | ization | force |
| No. | element | at % | ° C. | volume | phase | volume | at % | volume | nm | T | T | kA/m |
| 100 | — | — | 575 | 51 | — | 0 | — | 80 | 120 | 1.24 | 0.75 | 550 |
| 110 | Zr | 3.0 | 575 | 56 | ZrFe | 7.8 | 79 | 77 | 70 | 1.14 | 0.78 | 940 |
| 1-1 | Zr + B | 0.02 + 0.04 | 575 | 52 | — | — | — | 80 | 65 | 1.24 | 0.74 | 600 |
| 1-2 | Zr + B | 0.04 + 0.08 | 575 | 54 | ZrB | 0.1 | 5 | 79 | 45 | 1.22 | 0.80 | 1030 |
| 1-3 | Zr + B | 0.4 + 0.8 | 575 | 57 | ZrB | 0.85 | 5 | 79 | 35 | 1.21 | 0.83 | 1100 |
| 1-4 | Zr + B | 1.0 + 2.0 | 575 | 62 | ZrB | 2.6 | 8 | 77 | 30 | 1.20 | 0.84 | 1220 |
| 1-5 | Zr + B | 1.7 + 3.3 | 575 | 63 | ZrB | 4.3 | 8 | 77 | 30 | 1.20 | 0.84 | 1240 |
| 1-6 | Zr + B | 1.8 + 3.6 | 575 | 64 | ZrB | 5.0 | 12 | 69 | 30 | 1.10 | 0.73 | 1160 |
| 1-7 | Zr + B | 2.5 + 0.5 | 575 | 60 | ZrFe, ZrB | 3.7 | 54 | 72 | 40 | 1.12 | 0.68 | 870 |
| 1-8 | Zr + B | 1.5 + 1.5 | 575 | 62 | ZrFe, ZrB | 2.9 | 20 | 76 | 35 | 1.19 | 0.82 | 1020 |
| 1-9 | Zr + B | 0.75 + 2.25 | 575 | 58 | ZrB, FeB | 3.1 | 18 | 77 | 40 | 1.17 | 0.80 | 1000 |
| 1-10 | Zr + B | 0.5 + 2.3 | 575 | 56 | ZrB, FeB | 3.6 | 34 | 70 | 55 | 1.03 | 0.62 | 720 |
| 120 | Nb | 3.0 | 575 | 61 | NbFe | 5.0 | 67 | 78 | 75 | 1.18 | 0.80 | 810 |
| 1-21 | Nb + B | 1.0 + 2.0 | 575 | 60 | NbB | 2.1 | 5 | 81 | 35 | 1.21 | 0.85 | 1160 |

The results presented in Table 1 indicate that in samples 1-1 to 1-10 and 1-21, to which the Me and B are added as additive elements, the Fe phase tends to have a small average grain size and tends to be refined, compared with sample No. 100, to which neither Me nor B is added, and sample Nos. 110 and 120, to which the Me alone is added. Accordingly, the addition of the Me and B is effective in refining the Fe phase.

Among these, in samples 1-2 to 1-5, 1-8, 1-9, and 1-21, in which the total amount (content) of the Me and B added is 0.1 at % or more and 5.0 at % or less and in which the atomic percentage of Fe in the Me/B phase is 20 at % or less, the Fe phase has an average grain size of 50 nm or less and a relative density of 75% or more; thus, the refinement and an increase in the density of the Fe phase can both be achieved. These samples have a remanent magnetization of 0.80 T or more and a coercive force of 1,000 kA/m or more; thus, these samples have markedly improved remanent magnetization and coercive force and thus have good magnetic properties, compared with sample Nos. 100, 110, and 120. In these samples, the percentage of the Me/B phase is 5.0% or less by volume.

In contrast, sample No. 1-1, in which the total amount of the Me and B added is less than 0.1 at %, the Fe phase has an average grain size of more than 50 nm; thus, the refinement of the Fe phase is insufficient. A possible reason for this is as follows: In the case where the total amount of the Me and B added is less than 0.1 at %, the MeB phase is not sufficiently formed in the hydrogenation-disproportionation treatment, thus failing to inhibit the coarsening of the SmH₂ phase. Thus, the microstructure that has been subjected to phase decomposition in the hydrogenation-disproportionation treatment is not sufficiently refined. Accordingly, the microstructure that has been recombined by the desorption-recombination treatment is not refined, thus failing to sufficiently refine the Fe phase. Furthermore, the insufficient formation of the MeB phase fails to sufficiently inhibit the grain growth of the Fe phase in the desorption-recombination treatment, thus coarsening the Fe phase.

In sample No. 1-6, in which the total amount of the Me and B added is more than 5.0 at %, the relative density is less than 75%; thus, an increase in density is insufficient. A possible reason for this is as follows: in the case where the total amount of the Me and B added is more than 5.0 at %, the percentage of the Me/B phase (the ZrB phase in No. 1-6) is increased to degrade the formability.

In sample Nos. 1-7 and 1-10, in which the atomic percentage of Fe in the Me/B phases is more than 20 at %, the relative density is less than 75%; thus, an increase in density is insufficient. A possible reason for this is as follows: The high percentages of Fe in the Me/B phases result in the decrease of the Fe phase to degrade the formability; thus, sufficient formability cannot be provided. The reason the atomic percentage of Fe in the Me/B phases is more than 20 at % is presumably that because the amounts of Zr and B added deviate significantly from the combination ratio of Zr to B, excess Zr or B reacts with Fe to form large amounts of a ZrFe phase or a FeB phase.

### Test Example 2

Samples (Nos. 2-1 to 2-3) of rare-earth magnets presented in Table 2 were produced at different heat-treatment temperatures in hydrogenation-disproportionation treatment and evaluated.

In test example 2, the same Sm—Fe-Me-B-based alloy powder as that in sample No. 1-4 of test example 1 was provided as a starting material. Samples (Nos. 2-1 to 2-3) of compacted rare-earth magnets were produced under the same production conditions as in test example 1, except that the heat-treatment temperature in the hydrogenation-disproportionation treatment was changed in the range of 525° C. to 600° C. Table 2 lists the evaluation results.

TABLE 2

| | | | Hydrogenated alloy | | Magnet | | | | | | | |
|---|---|---|---|---|---|---|---|---|---|---|---|---|
| | | | Hydrogen- | Volume | | Volume | | | | | | |
| | Material alloy | | ation- | percentage | | percentage | | | | | | |
| | | Amount | dispropor- | of | | of | Percentage | | Grain | | | |
| | Type | of | tionation | SmFe₉ | Type | Me/B | of Fe in | Relative | size | Saturation | Remanent | |
| | of | Me + B | temper- | phase | of | phase | Me/B | density | of Fe | magnet- | magnet- | Coercive |
| Sample | additive | added | ature | % by | Me/B | % by | phase | % by | phase | ization | ization | force |
| No. | element | at % | ° C. | volume | phase | volume | at % | volume | nm | T | T | kA/m |
| 2-1 | Zr + B | 1.0 + 2.0 | 525 | 77 | ZrB | 2.5 | 8 | 68 | 30 | 1.09 | 0.72 | 1260 |
| 2-2 | Zr + B | 1.0 + 2.0 | 550 | 65 | ZrB | 2.6 | 8 | 76 | 30 | 1.18 | 0.82 | 1200 |
| 1-4 | Zr + B | 1.0 + 2.0 | 575 | 62 | ZrB | 2.6 | 8 | 77 | 30 | 1.20 | 0.84 | 1220 |
| 2-3 | Zr + B | 1.0 + 2.0 | 600 | 55 | ZrB | 2.6 | 8 | 79 | 35 | 1.21 | 0.80 | 1150 |

The results presented in Table 2 indicate that in sample Nos. 2-2, 1-4, and 2-3, in which the hydrogenation-disproportionation temperature is 550° C. or higher, the percentage of the SmFe₉ structure phase (SmFe₉ phase) in the hydrogenated alloy is 65% or less by volume, and a relative density of 75% or more can be ensured. In these samples, the Fe phase has an average grain size of 50 nm or less. Thus, the refinement and an increase in the density of the Fe phase can both be achieved. These samples have a remanent magnetization of 0.80 T or more and a coercive force of 1,000 kA/m or more; thus, these samples have high remanent magnetization and high coercive force. A possible reason for this is as follows: because the percentage of the SmFe₉ phase is 65% or less by volume, the refinement of the Fe phase results in significantly improved magnetic properties while the formability is sufficiently enhanced.

In contrast, in sample No. 2-1, in which the hydrogenation-disproportionation temperature is 525° C., the percentage of the SmFe₉ structure phase in the hydrogenated alloy is more than 65% by volume, and the relative density is less than 75%. A possible reason for this is as follows: Because of the low hydrogenation-disproportionation temperature, the Sm—Fe-Me-B-based alloy serving as a raw material cannot be sufficiently subjected to phase decomposition to increase the percentage of the remaining SmFe₉ structure phase undecomposed, thereby degrading the formability.

The embodiments disclosed herein are to be considered in all respects as illustrative and not limiting. The scope of the invention is defined not by the foregoing description but by the following claims, and is intended to include any modifications within the scope and meaning equivalent to the scope of the claims.

### REFERENCE SIGNS LIST

100 Sm—Fe-Me-B-based alloy, 10 SmFe₉ structure phase, 101 hydrogenated alloy, 20 mixed crystal region, 21 SmH₂ phase, 22 Fe phase, 23 MeB phase, 102 mixed crystal body, 12 Sm₂Fe₁₇ phase, 110 rare-earth magnet, 111 SmFe₉N_{y} phase, 121 Sm₂Fe₁₇Nₓ phase

1. A rare-earth magnet containing Sm, Fe, and N, comprising:
an Me and B serving as additive elements,
the Me representing at least one element selected from elements in groups 4, 5, and 6 of the periodic table; and
a nanocomposite microstructure including an Fe phase, a SmFeN phase, and an MeB phase,
wherein the SmFeN phase includes at least a Sm₂Fe₁₇Nₓ phase selected from the Sm₂Fe₁₇Nₓ phase and a SmFe₉N_{y} phase,
a volume percentage of the SmFe₉N_{y} phase in the microstructure is 65% or less by volume,
an atomic percentage of a total content of the Me and B is 0.1 at % or more and 5.0 at % or less with respect to a total amount of Sm, Fe, the Me, and B, and
an atomic percentage of Fe in all phases of compounds each containing at least one of the Me and B is 20 at % or less.

2. The rare-earth magnet according to claim 1, wherein the Me represents at least one element selected from Zr, Nb, and Ti.

3. The rare-earth magnet according to claim 1, wherein the Fe phase has an average grain size of 50 nm or less.

4. The rare-earth magnet according to claim 1, wherein the rare-earth magnet has a relative density of 75% or more.

5. A method for producing a rare-earth magnet, comprising:
a provision step of providing a Sm—Fe-Me-B-based alloy having a SmFe₉ structure serving as a main phase, the Sm—Fe-Me-B-based alloy containing an Me and B, by rapidly cooling a molten alloy containing Sm and Fe serving as main components, the Me and B being incorporated into the molten alloy;
a hydrogenation-disproportionation step of subjecting the Sm—Fe-Me-B-based alloy to hydrogenation-disproportionation treatment by heat treatment in a hydrogen-containing atmosphere to decompose at least part of the Sm—Fe-Me-B-based alloy into a SmH₂ phase, an Fe phase, and an MeB phase through a disproportionation reaction;
a formation step of pressure-forming the Sm—Fe-Me-B-based alloy that has been subjected to the hydrogenation-disproportionation treatment to provide a formed article;
a desorption-recombination step of subjecting the formed article to desorption-recombination treatment by heat treatment in an inert atmosphere or a reduced-pressure atmosphere to allow the SmH₂ phase and the Fe provided by decomposition in the hydrogenation-disproportionation treatment to recombine through a recombination reaction; and
a nitriding step of subjecting the formed article that has been subjected to the desorption-recombination treatment to nitriding treatment by heat treatment in a nitrogen-containing atmosphere,
wherein the Me represents at least one element selected from elements in groups 4, 5, and 6 of the periodic table,
in the provision step, the Me and B are incorporated such that an atomic percentage of a total content of the Me and B is 0.1 at % or more and 5.0 at % or less with respect to a total amount of Sm, Fe, the Me, and B and such that an atomic percentage of Fe in all phases of compounds each containing at least one of the Me and B, the compounds being formed in the hydrogenation-disproportionation treatment, is 20 at % or less, and
in the hydrogenation-disproportionation treatment, a volume percentage of the phase of the SmFe₉ structure in the Sm—Fe-Me-B-based alloy that has been subjected to the hydrogenation-disproportionation treatment is 65% or less by volume.

6. The method for producing a rare-earth magnet according to claim 5, further comprising a pulverization step of pulverizing the Sm—Fe-Me-B-based alloy before the formation step.

7. The method for producing a rare-earth magnet according to claim 5, wherein in the provision step, the Sm—Fe-Me-B-based alloy is produced by rapid cooling using a melt-spinning method.
